(19) United States
(12) Patent Application Publication
(10) Pub. No.: US 2021/0296716 A1
(43) Pub. Date: Sep. 23, 2021

(54) BATTERY COOLING SYSTEM AND METHOD OF OPERATING SAME

(71) Applicant: Global Graphene Group, Inc., Dayton, OH (US)

(72) Inventors: Aruna Zhamu, Springboro, OH (US); Bor Z. Jang, Centerville, OH (US)

(21) Appl. No.: 16/827,067

(22) Filed: Mar. 23, 2020

(51) Int. Cl. H01M 10/613; H01M 10/655; H01M 10/653

(52) U.S. Cl. CPC H01M 10/613; H01M 10/653; H01M 10/655

(57) ABSTRACT

Provided is a battery module cooling system, comprising a graphene heat spreader element (preferably in the form of a film, sheet, layer, belt, band, etc.) configured to abut at least one of the battery cells; and a cooling means in thermal communication with the heat spreader element and configured to transport heat generated from the battery cell(s) through the heat spreader element to the cooling means when the battery cells are discharged. Also provided is a method of operating a battery cooling system, comprising: (a) bringing a graphene heat spreader element in thermal contact with a plurality of battery cells in a module and receiving heat therefrom; and (b) directing the heat to transport through the graphene heat spreader element to a cooling means which acts to remove the heat and keep the battery below a desired temperature.

### FIELD

The present disclosure relates generally to the field of batteries and, in particular, to the cooling systems for rechargeable batteries.

### BACKGROUND

Electric vehicles (EVs) are viewed as a promising solution to CO₂ emission and climate change issues. Batteries have been at the heart of the rapidly emerging EV industry. The service life, capacity, and internal resistance of various types of rechargeable batteries, particularly the lithium-ion battery, are sensitive to temperature changes.

One major problem is the danger of overheating, allowing a large amount of current to reach a location in an extremely short period of time, creating local hot spots that can significantly degrade or damage the various component materials (anode, cathode, separator, and electrolyte, etc.) of a battery cell. Under extreme conditions, the local heat may cause the liquid electrolyte of a battery to catch fire, leading to fire and explosion hazards. Battery life may be reduced by ⅔ in hot climates during aggressive driving and without cooling. With a battery temperature exceeding the stable point, severe exothermic reactions can occur uncontrollably. In addition, if a lithium-ion battery approaches thermal runaway, only 12% of the total heat released in the battery is enough to trigger thermal runaway in adjacent battery cells. This is the biggest risk during the use of lithium-ion batteries. In order not to compromise the service life of a battery, it is important to design a battery module with good heat dissipation performance.

More commonly used battery thermal management methods include air cooling, liquid cooling, and phase change material (PCM) cooling, Air cooling can meet the thermal management requirements of the vehicles under some ordinary conditions. However, when the EV accelerates or operates at a high velocity, the battery is discharged at a high rate, generating heat at a fast pace. Under these conditions, conventional air cooling is unable to meet the cooling requirements for electric vehicles.

Phase change material (PCM) cooling system controls the temperature of the battery module by the heat absorption and heat release when the material undergoes phase changes. Power battery cooling experiments using PCM are easier to meet the needs of the lithium battery cooling system, but the high costs have prevented more widespread use of PCMs in electric vehicles.

The liquid cooling system can exhibit higher cooling efficiency and reliability. The liquid cooling system requires good sealing and fluid pumping accessories. The cooling performance of lithium-ion pouch or prismatic cells may be improved with cold plates implemented along both surfaces of a cell and by changing the inlet coolant mass flow rates and the inlet coolant temperatures. The enhanced cooling energy efficiency can be achieved with a low inlet coolant temperature, low inlet coolant mass flow rate, and a high number of the cooling channels.

Numerous methods have been proposed to improve the cooling performance. For air or liquid cooling, for example, increasing the coolant velocity or the size of cooling structure may benefit the average temperature and temperature uniformity. However, such improvements increase the pack volume and weight, resulting in a larger power consumption of the battery thermal management system (BTMS).

Overheating or thermal runaway of a battery, leading to the battery catching fire or battery explosion, has been a serious barrier against the acceptance of battery-driven EVs. There has been no effective approach to overcoming this battery safety problem without adding significant weight, volume, and complexity of the thermal management system. An urgent need exists for a battery system that can be operated in a safe mode free from any thermal runaway problem.

An object of the present disclosure is to provide a cooling system that enables the battery module/pack to operate in a safe mode with reduced or eliminated chance of overheating and without significantly increasing cooling system weight, volume, and complexity. Another object of the disclosure is to provide a method of operating such a cooling system and apparatus.

### SUMMARY

It may be noted that the word “electrode” herein refers to either an anode (negative electrode) or a cathode (positive electrode) of a battery. These definitions are also commonly accepted in the art of batteries or electrochemistry. In battery industry, a module comprises a plurality of battery cells packaged together. A pack comprises a plurality of modules aggregated together. The presently disclosed cooling system can be used to cool one or a plurality of battery cells, regardless if or not they are packed into a module or pack or simply some individual battery cells. The term “battery” can refer to a battery cell or several battery cells connected together.

The present disclosure provides a cooling system for a battery module or pack (comprising one or a plurality of battery cells), wherein the system comprises (a) a graphene heat spreader element or member (preferably in the form of a film, sheet, layer, belt, band, etc.) configured to be in thermal communication with the battery cells (e.g. to abut at least one of the battery cells or in contact with a thermal interface material which, in turn, in thermal contact with at least one of battery cells); and (b) a cooling means in thermal communication with the heat spreader element and configured to transport heat generated by the battery cell(s) through the heat spreader element to the cooling means when the battery cell is operated (e.g. discharged).

The cooling system may preferably further comprise a thermal interface material (TIM) coupled to at least one of the battery cells and the heat spreader element.

In certain embodiments, the graphene heat spreader element is in a form of a graphene film, sheet, layer, belt, or band having a thickness from about 0.34 nm to 10 mm (preferably from 10 nm to 1 mm and further preferably from 100 nm to 500 μm).

In certain embodiments, the graphene heat spreader element has a thermal conductivity no less than 600 W/mK, preferably no less than 800 W/mK, further preferably no less than 1,000 W/mK, still further preferably no less than 1,200 W/mK, and most preferably no less than 1,500 W/mK (up to 1,800 W/mK).

In some embodiments, the graphene heat spreader element comprises a graphene film containing sheets of a graphene material selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

The thermal interface material may comprise a material selected from graphene sheets, graphene foam, graphene-containing paste, graphene-containing composite (e.g. graphene sheets dispersed in a plastic or rubber matrix), flexible graphite sheet, artificial graphite film, particles of Ag, Ag, Cu, Al, brass, steel, Ti, Ni, Mg alloy, silicon nitride, boron nitride, aluminum nitride, boron arsenide, a composite thereof, or a combination thereof.

Preferably, the thermal interface material is electrically insulating and thermally conducting, having a thermal conductivity no less than 1 W/mK (preferably no less than 5 W/mK and further preferably no less than 10 W/mK). Although graphene sheets individually are electrically conducting, by dispersing graphene sheets in a plastic or rubber matrix one can obtain a composite that is electrically insulating and thermally conductive. The resulting graphene-reinforced polymer composite can be made to exhibit a thermal conductivity greater than 1 W/mK, typically up to 10 W/mK.

In certain preferred embodiments, the thermal interface material comprises a graphene foam having a thermal conductivity from 0.1 W/mK to 100 W/mK (preferably >1 W/mK and more preferably >10 W/mK) and the graphene heat spreader element comprises a graphene film having a thermal conductivity from 600 W/mK to 1,800 W/mK.

The cooling means is designed to cool down a battery cell or multiple battery cells in a module or pack when the battery is discharged (e.g. when the cell(s) are operated to power an electronic device or EV motor). The heat generated by a cell is transported, preferably through a thermal interface material, to the heat spreader element, which transports the heat to the cooling means.

The cooling means is preferably selected from a heat sink, a heat pipe, a vapor chamber, a stream of flowing fluid (when an EV is in motion, air may be directed to flow into contact with the heat spreader tabs, for instance), a bath of a coolant fluid, a thermoelectric device, a cooled plate, a heat exchanger, a radiator, or a combination thereof.

In some embodiments, the heat-spreader element acts as a temperature sensor for measuring the surface temperature of the battery. For instance, a graphene sheet exhibits a resistance that varies with the surrounding temperature and, as such, a simple resistance measurement may be used to indicate the local temperature where the graphene sheet is disposed.

In certain embodiments, the heat-spreader element comprises a high thermal conductivity material having a thermal conductivity no less than 10 W/mK. Preferably, the heat-spreader element comprises a material selected from graphene film (e.g. composed of graphene sheets aggregated together or bonded together into a film or sheet form). The graphene film may contain a graphene selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

In certain embodiments, the heat-spreader element has a heat-spreading area in contact with at least one of the six surfaces of a rectangular-shape battery cell. In this application, the heat spreader element is preferably flat and has a large heat-spreading area having a length-to-thickness ratio greater than 10, preferably greater than 50, more preferably greater than 100, and further more preferably greater than 500. The heat-spreader element typically has a thickness from about 0.5 μm to about 1 mm, but can be as thin as 0.34 nm and as thick as several centimeters.

In the cooling system, the heat spreader element may be configured to form multiple loading sites (pores) for accommodating individual battery cells. In some embodiments, the lodging sites comprise cylindrical pores to accommodate cylindrical-shape battery cells or rectangular pores to accommodate rectangular-shape battery cells.

The battery module may contain a battery cell selected from a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, or supercapacitor cell.

The present disclosure also provides a method of operating a battery cooling system, the method comprising: (a) bringing a graphene heat spreader element (member) to be in thermal contact with one or a plurality of battery cells in a module or pack and to receive heat from the battery cells; and (b) directing the heat to transport through the graphene heat spreader element to a cooling means which acts to remove the heat and keeps the battery temperature at or below a desired temperature.

In certain embodiments, a thermal interface material (TIM) is disposed between a surface of a battery cell (e.g. one of the 6 surfaces of a rectangular cell or the cylindrical surface of a cylindrical cell) and the heat spreader element. The TIM ensures good thermal contact between a battery cell and a graphene heat spreader element and, thereby, reduces the interfacial resistance. The thermal interface material preferably comprises a material selected from graphene sheets, graphene foam, graphene-containing paste, graphene-containing polymer composite, flexible graphite sheet, artificial graphite film, particles of Ag, Ag, Cu, Al, brass, steel, Ti, Ni, Mg alloy, silicon nitride, boron nitride, aluminum nitride, boron arsenide, a composite thereof, or a combination thereof.

The graphene heat spreader element preferably has a thermal conductivity from 10 W/mK to 1,800 W/mK. The graphene heat spreader element preferably comprises a graphene film containing a graphene material selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

The cooling means may be selected from a heat sink, a heat pipe, a vapor chamber, a stream of flowing fluid, a bath of a coolant fluid, a thermoelectric device, a cooled plate (cold plate), a heat exchanger, a radiator, or a combination thereof.

### BRIEF DESCRIPTION OF THE DRAWINGS

FIG. 1(A) Schematic of a battery cooling system according to an embodiment of the present disclosure; multiple battery cells may be thermally attached to one primary surface or two primary surfaces of a graphene heat spreader element (e.g. a graphene film).

FIG. 1(B) Schematic of a battery cooling system according to another embodiment of the present disclosure; a thermal interface material provides intimate thermal contact between a battery cell and a graphene heat spreader element, which is, in turn, thermally connected to a heat sink.

FIG. 1(C) Schematic of a disclosed battery cooling system that comprises a continuous graphene belt (a graphene heat spreader element or member) in thermal contact with multiple battery cells through a thin layer of a thermal interface material. The graphene heat spreader element is in thermal communication with a cooling means (not shown).

FIG. 1(D) Schematic of a battery cooling system, according to an embodiment of the present disclosure. The cooling system comprises multiple cylindrical pores having pore walls composed of graphene thermal films or graphene composites as a graphene heat spreader element.

FIG. 2 A diagram showing a procedure for producing graphene oxide sheets. These sheets can then be aggregated (e.g. roll-pressed) together or slurry-coated together, followed by a heat treatment procedure to produce graphene films.

### DETAILED DESCRIPTION OF PREFERRED EMBODIMENTS

The present discussion of preferred embodiments makes use of lithium-ion battery as an example. The present disclosure is applicable to a wide array of rechargeable batteries, not limited to the lithium-ion batteries. Examples of the rechargeable batteries include the lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, and supercapacitor.

Battery thermal management (BTM) systems can be divided into two groups: active BTM systems and passive BTM systems. An active BTM system dissipates the heat generated from batteries by circulating the cooling air or coolant around the batteries. This system generally needs a power-consuming device, such as a pump or a cooling fan, to circulate the cooling medium. An active BTM system is efficient in managing the battery temperature, but it consumes part of the battery energy and adds complexities to the system.

In contrast, a passive BTM system absorbs the heat generated from batteries by filling cooling materials with high specific heat (e.g. water/glycol mixture) in between batteries. A passive BTM system may also make use of a phase change material (PCM). Amongst the drawbacks of passive BTM systems is that the addition of the cooling material increases the weight of the battery system and reduces the volume of active charge storing material, thus reducing the specific energy of the battery system. Accordingly, there is a drive to use the minimum amount of cooling material to achieve the best cooling effect and minimal reduction in the specific energy of a secondary battery.

The present disclosure provides a cooling system for a battery module (comprising one or a plurality of battery cells), wherein the system comprises (a) a graphene heat spreader element (preferably in the form of a graphene film, sheet, layer, belt, band, etc.) configured to be in thermal communication with the battery cells (e.g. to abut at least one of the battery cells or in contact with a thermal interface material which is, in turn, in thermal contact with at least one of the battery cells); and (b) a cooling means in thermal communication with the graphene heat spreader element and configured to transport heat generated by the battery cell(s) through the heat spreader element into a cooling means.

Due to the exceptionally high thermal conductivity of graphene (the highest among all materials known to scientists), such implementation of a graphene heat spreader member can rapidly transport the heat out of the battery cells, reducing or eliminating the need to have complex, bulky or heavy cooling apparatus. The disclosed cooling system per se can be a passive cooling system or part of an active cooling system.

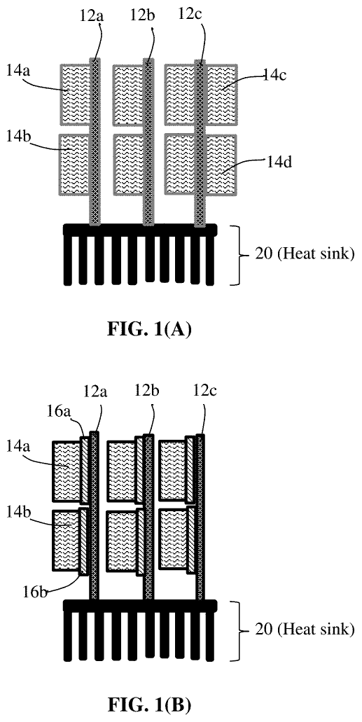

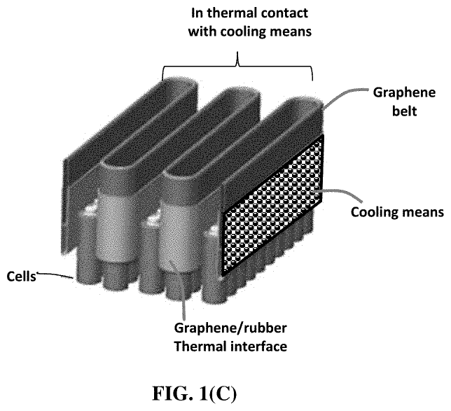

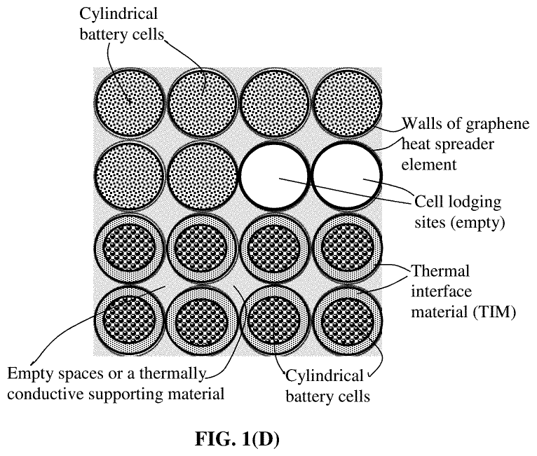

As illustrated in FIG. 1(A), according to some embodiments of the disclosure, the battery cells (e.g. 14a, 14b, 14c, 14d) are in thermal or physical contact with a graphene heat spreader element (e.g. containing graphene films 12a, 12b, or 12c), which is, in turn, in thermal or physical contact with a cooling means (e.g. a heat sink 20, vapor chamber, or cooled plate). The heat generated by a battery cell during cell discharging is transferred to a graphene thermal film which rapidly spreads the heat over to a cooling means (e.g. a finned heat sink 20 in FIG. 1(A)). The heat spreading rate in the graphene-based heat spreader element can be exceptionally high due to the high thermal conductivity of graphene.

The cooling system may preferably further comprise a thermal interface material (TIM) coupled to at least one of the battery cells and the heat spreader element. As illustrated in FIG. 1(B), A TIM (e.g. 16a or 16b) is implemented between a battery cell (e.g. 14a or 14b) and a graphene heat spreader element (e.g. 12a). The presence of a TIM enables a good thermal contact between a heat spreader element and a battery cell (a heat source).

Illustrated in FIG. 1(C) is portion of a disclosed battery cooling system that comprises a continuous graphene belt (a graphene heat spreader element or member). The continuous graphene belt runs through the gaps between rows (or modules) of battery cells. A thermal interface material (e.g. a graphene-reinforced rubber matrix composite or a graphene foam) is disposed between the battery cells and the graphene heat spreader element. Heat generated from battery cells is transported through the thermal interface material into the graphene heat spreader element. Due to the exceptionally high thermal conductivity of the graphene material, heat can rapidly spread from the battery cell contact points to a far end or other portion of the heat spreader element where the heat spreader is in thermal communication with a cooling means (e.g. a liquid coolant bath, a stream of flowing air, a heat pipe, a finned heat sink, a radiator, etc.). Heat is then dissipated or removed by the cooling means.

Schematically shown in FIG. 1(D) is a battery cooling system, according to an embodiment of the present disclosure. The battery pack equipped with such a cooling system may be disposed in the chassis of an electric vehicle. In certain embodiments, the cooling system comprises multiple cylindrical pores having pore walls constituted by graphene thermal films or graphene composite (graphene heat spreader element). Cylindrical battery cells may be directly fit into the pores (the cell-lodging sites), as illustrated in the upper two rows of FIG. 1(D). There can be a cylindrical shell of a TIM disposed between the graphene heat spreader element wall and a cylindrical battery cell, as illustrated in the lower two rows of FIG. 1(D). It may be noted that the cell-lodging pores do not have to be cylindrical in shape and can be of any shape conformal to the actual battery cell shape. The graphene heat spreader element is in thermal communication with a cooling means (not shown). When the battery cells in the pack are discharged to drive the EV, the cooling system keeps the battery lower than a safe temperature.

There is no limitation on the type of cooling means that can be implemented to cool down the battery cells when working to power an electronic device or an EV. The cooling means may be selected from a heat sink, a heat pipe, a vapor chamber, a stream of flowing fluid, a thermoelectric device, a cooled/refrigerated plate, a heat exchanger, a radiator, or a combination thereof.

It is important that the heat spreader element has a high thermal conductivity to allow for rapid transfer of a large amount of heat from the battery surface through the heat spreader element to a cooling means when the cell is discharged.

In certain embodiments, the heat-spreader element comprises a high thermal conductivity material having a thermal conductivity no less than 10 W/mK (preferably no less than 200 W/mK, further preferably greater than 600 W/mK, more preferably greater than 1,000 W/mK, and most preferably greater than 1,500 W/mK). Preferably, the heat-spreader element comprises a material selected from graphene film (e.g. composed of graphene sheets aggregated together or bonded together into a film or sheet form, typically having a thermal conductivity from 800 W/mK to 1,800 W/mK and a thickness from 10 nm to 5 mm) or graphene-reinforced composite.

The thermal interface material may comprise a material selected from graphene sheets, graphene foam, graphene-containing paste, graphene-containing polymer composite, flexible graphite sheet, artificial graphite film, particles of Ag, Ag, Cu, Al, brass, steel, Ti, Ni, Mg alloy, silicon nitride, boron nitride, aluminum nitride, boron arsenide, a composite thereof, or a combination thereof. Thermal interface materials are well-known in the art.

The graphene film contains a graphene selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof. The graphene film typically exhibits a thermal conductivity from 800 to 1,800 W/mK. Flexible graphite sheet typically exhibits a thermal conductivity from 150 to 600 W/mK. Artificial graphite films (e.g. those produced by carbonizing and graphitizing a polymer film) can exhibit a thermal conductivity from 600 to 1,700 W/mK. Graphene films, flexible graphite sheets, and artificial graphite films are commonly regarded as three distinct classes of materials.

In some embodiments, the battery cooling system further comprises at least a temperature sensor for measuring the surface temperature of the battery cells. In some embodiments, the heat-spreader element acts as a temperature sensor for measuring an internal temperature of the battery. For instance, the graphene sheet exhibits a resistance that varies with the surrounding temperature and, as such, a simple resistance measurement may be used to indicate the local temperature where the graphene sheet is disposed.

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In other words, graphene planes (hexagonal lattice structure of carbon atoms) constitute a significant portion of a graphite particle.

A single-layer graphene sheet is composed of carbon atoms occupying a two-dimensional hexagonal lattice. Multi-layer graphene is a platelet composed of more than one graphene plane.

Individual single-layer graphene sheets and multi-layer graphene platelets are herein collectively called nano graphene platelets (NGPs) or graphene materials. NGPs include pristine graphene (essentially 99% of carbon atoms), slightly oxidized graphene (<5% by weight of oxygen), graphene oxide (≥5% by weight of oxygen), slightly fluorinated graphene (<5% by weight of fluorine), graphene fluoride ((≥5% by weight of fluorine), other halogenated graphene, and chemically functionalized graphene.

Our research group was among the first to discover graphene [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. The processes for producing NGPs and NGP nanocomposites were recently reviewed by us [Bor Z. Jang and A Zhamu, “Processing of Nano Graphene Platelets (NGPs) and NGP Nanocomposites: A Review,” J. Materials Sci. 43 (2008) 5092-5101]. The production of various types of graphene sheets is well-known in the art.

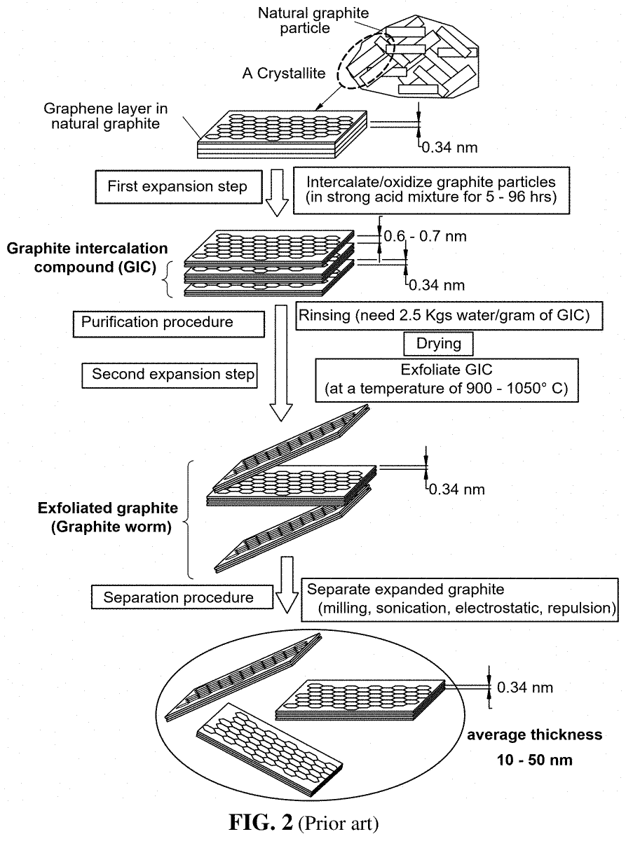

For instance, as shown in FIG. 2, the chemical processes for producing graphene sheets or platelets typically involve immersing powder of graphite or other graphitic material in a mixture of concentrated sulfuric acid, nitric acid, and an oxidizer, such as potassium permanganate or sodium perchlorate, forming a reacting mass that requires typically 5-120 hours to complete the chemical intercalation/oxidation reaction. Once the reaction is completed, the slurry is subjected to repeated steps of rinsing and washing with water. The purified product is commonly referred to as graphite intercalation compound (GIC) or graphite oxide (GO). The suspension containing GIC or GO in water may be subjected to ultrasonication to produce isolated/separated graphene oxide sheets dispersed in water. The resulting products are typically highly oxidized graphene (i.e. graphene oxide with a high oxygen content), which must be chemically or thermal reduced to obtain reduced graphene oxide (RGO).

Alternatively, the GIC suspension may be subjected to drying treatments to remove water. The dried powder is then subjected to a thermal shock treatment. This can be accomplished by placing GIC in a furnace pre-set at a temperature of typically 800-1100° C. (more typically 950-1050° C.) to produce exfoliated graphite (or graphite worms), which may be subjected to a high shear or ultrasonication treatment to produce isolated graphene sheets.

Alternatively, graphite worms may be re-compressed into a film form to obtain a flexible graphite sheet, which is a fundamentally distinct material than graphene film. Flexible graphite sheet has a thermal conductivity from 100 to 500 W/mK and, in contrast, graphene film has a thermal conductivity from 800 to 1,800 W/mK. Flexible graphite sheets are commercially available from many sources worldwide.

The starting graphitic material may be selected from natural graphite, synthetic graphite, highly oriented pyrolytic graphite, graphite fiber, graphitic nano-fiber, graphite fluoride, chemically modified graphite, meso-carbon micro-bead, partially crystalline graphite, or a combination thereof.

Pristine graphene sheets may be produced by the well-known liquid phase exfoliation or metal-catalyzed chemical vapor deposition (CVD).

The highly oriented graphene film (HOGF), as a heat spreader element, may be produced from graphene oxide, graphene fluoride, etc. There is no theoretical limit on the thickness of the HOGF that can be produced using the presently disclosed process. As an example, the process for producing a graphene thermal film (for use as a graphene heat spreader element) includes:

(a) preparing either a graphene oxide dispersion (GO suspension) having graphene oxide sheets dispersed in a fluid medium or a GO gels having GO molecules dissolved in a fluid medium, wherein the GO sheets or GO molecules contain an oxygen content higher than 5% by weight (typically higher than 10%, more typically higher than 20%, often higher than 30%, and can be up to approximately 50% by weight);

(b) dispensing and depositing the GO dispersion or GO gel onto a surface of a supporting solid substrate to form a layer of graphene oxide (wet layer) having a (wet) thickness preferably less than 10 mm (preferably less than 2.0 mm, more preferably less than 1 mm, and most preferably less than 0.5 mm), wherein the dispensing and depositing procedure (e.g. coating or casting) includes subjecting the graphene oxide dispersion to an orientation-inducing stress;

(c) partially or completely removing the fluid medium from the wet layer of graphene oxide to form a dried layer of graphene oxide having a dried layer thickness less than 2 mm and having an inter-plane spacing d₀₀₂ of 0.4 nm to 1.2 nm as determined by X-ray diffraction and an oxygen content no less than 5% by weight; and

(d) heat treating the layer of dried graphene oxide under an optional compressive stress to produce the highly oriented graphene film at a heat treatment temperature higher than 100° C. (typically from 500° C. to 3,000° C.) to an extent that an inter-plane spacing d₀₀₂ is decreased to a value less than 0.4 nm and the oxygen content is decreased to less than 5% by weight. The resulting graphene film may be further compressed to reduce the thickness and increase the physical density of the film. The desired physical density of the graphene film is from 1.7 g/cm³ to 2.25 g/cm³.

In one embodiment, wherein the heat treatment temperature contains a temperature in the range from 500° C-1,500° C., the resulting highly oriented graphene film structure has an oxygen content less than 1%, an inter-graphene spacing less than 0.345 nm, a thermal conductivity of at least 1,000 W/mK, and/or an electrical conductivity no less than 3,000 S/cm.

In another embodiment, wherein the heat treatment temperature contains a temperature in the range from 1,500° C.-2,100° C., the highly oriented graphene film structure has an oxygen content less than 0.01%, an inter-graphene spacing less than 0.337 nm, a thermal conductivity of at least 1,300 W/mK, and/or an electrical conductivity no less than 5,000 S/cm.

In a preferred embodiment, wherein the heat treatment temperature contains a temperature greater than 2,100° C., the highly oriented graphene structure has an oxygen content no greater than 0.001%, an inter-graphene spacing less than 0.336 nm, a mosaic spread value no greater than 0.7, a thermal conductivity of at least 1,500 W/mK, and/or an electrical conductivity no less than 10,000 S/cm.

In another preferred embodiment, wherein the heat treatment temperature contains a temperature no less than 2,500° C., the highly oriented graphene film structure has an inter-graphene spacing less than 0.336 nm, a mosaic spread value no greater than 0.4, a thermal conductivity greater than 1,600 W/mK, and/or an electrical conductivity greater than 10,000 S/cm.

Typically, the highly oriented graphene film structure exhibits an inter-graphene spacing less than 0.337 nm and a mosaic spread value less than 1.0. More typically, the highly oriented graphene structure exhibits a degree of graphitization no less than 80% (preferably and more typically no less than 90%) and/or a mosaic spread value less than 0.4.

Due to the notion that highly aligned GO sheets or GO molecules can be chemically merged together in an edge-to-edge manner, the resulting highly oriented graphene structure has a grain size that is significantly larger than the maximum grain size of the starting graphitic material prior to or during oxidation of the graphitic material. In other words, if the graphene oxide dispersion is obtained from a graphitic material having a maximum original graphite grain size, then the resulting highly oriented graphene structure is normally a single crystal or a poly-crystal graphene structure having a grain size larger than this maximum original grain size.

Internal structure-wise, the highly oriented graphene structure contains chemically bonded graphene planes that are parallel to one another. The graphene oxide dispersion is typically obtained from a graphitic material having multiple graphite crystallites exhibiting no preferred crystalline orientation as determined by an X-ray diffraction or electron diffraction method. However, the highly oriented graphene structure is typically a single crystal or a poly-crystal graphene structure having a preferred crystalline orientation as determined by said X-ray diffraction or electron diffraction method. In some cases, the highly oriented graphene structure contains a combination of sp² and sp³ electronic configurations. In the disclosed process, the step of heat-treating induces chemical linking, merging, or chemical bonding of graphene oxide molecules, and/or re-graphitization or re-organization of a graphitic structure.

One of the more desirable thermal interface materials for use in the presently disclosed battery cooling system is graphene foam.

Generally speaking, a foam or foamed material is composed of pores (or cells) and pore walls (a solid material). The pores can be interconnected to form an open-cell foam. A graphene foam is composed of pores and pore walls that contain a graphene material. There are four major methods of producing graphene foams:

The first method is the hydrothermal reduction of graphene oxide hydrogel that typically involves sealing graphene oxide (GO) aqueous suspension in a high-pressure autoclave and heating the GO suspension under a high pressure (tens or hundreds of atm) at a temperature typically in the range from 180-300° C. for an extended period of time (typically 12-36 hours). A useful reference for this method is given here: Y. Xu, et al. “Self-Assembled Graphene Hydrogel via a One-Step Hydrothermal Process,” ACS Nano 2010, 4, 4324-4330.

The second method is based on a template-assisted catalytic CVD process, which involves CVD deposition of graphene on a sacrificial template (e.g. Ni foam). The graphene material conforms to the shape and dimensions of the Ni foam structure. The Ni foam is then etched away using an etching agent, leaving behind a monolith of graphene skeleton that is essentially an open-cell foam. A useful reference for this method is given here: Zongping Chen, et al., “Three-dimensional flexible and conductive interconnected graphene networks grown by chemical vapor deposition,” Nature Materials, 10 (June 2011) 424-428.

The third method of producing graphene foam also makes use of a sacrificial material (e.g. colloidal polystyrene particles, PS) that is coated with graphene oxide sheets using a self-assembly approach. For instance, Choi, et al. prepared chemically modified graphene (CMG) paper in two steps: fabrication of free-standing PS/CMG films by vacuum filtration of a mixed aqueous colloidal suspension of CMG and PS (2.0 μm PS spheres), followed by removal of PS beads to generate 3D macro-pores. [B. G. Choi, et al., “3D Macroporous Graphene Frameworks for Supercapacitors with High Energy and Power Densities,” ACS Nano, 6 (2012) 4020-4028.] Choi, et al. fabricated well-ordered free-standing PS/CMG paper by filtration, which began with separately preparing a negatively charged CMG colloidal and a positively charged PS suspension. A mixture of CMG colloidal and PS suspension was dispersed in solution under controlled pH (=2), where the two compounds had the same surface charges (zeta potential values of +13±2.4 mV for CMG and +68±5.6 mV for PS). When the pH was raised to 6, CMGs (zeta potential=−29±3.7 mV) and PS spheres (zeta potential=+51±2.5 mV) were assembled due to the electrostatic interactions and hydrophobic characteristics between them, and these were subsequently integrated into PS/CMG composite paper through a filtering process.

The fourth method for producing a solid graphene foam composed of multiple pores and pore walls was invented by us earlier [Aruna Zhamu and Bor Z. Jang, “Highly Conductive Graphene Foams and Process for Producing Same,” U.S. patent application Ser. No. 14/120,959 (Jul. 17, 2014)]. The process comprises:

(a) preparing a graphene dispersion having a graphene material dispersed in a liquid medium, wherein the graphene material is selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof and wherein the dispersion contains an optional blowing agent;

(b) dispensing and depositing the graphene dispersion onto a surface of a supporting substrate (e.g. plastic film, rubber sheet, metal foil, glass sheet, paper sheet, etc.) to form a wet layer of graphene material, wherein the dispensing and depositing procedure includes subjecting the graphene dispersion to an orientation-inducing stress;

(c) partially or completely removing the liquid medium from the wet layer of graphene material to form a dried layer of graphene material having a content of non-carbon elements (e.g. O, H, N, B, F, Cl, Br, I, etc.) no less than 5% by weight; and

(d) heat treating the dried layer of graphene material at a first heat treatment temperature from 100° C. to 3,200° C. at a desired heating rate sufficient to induce volatile gas molecules from the non-carbon elements or to activate said blowing agent for producing the solid graphene foam having a density from 0.01 to 1.7 g/cm³ (more typically from 0.1 to 1.5 g/cm³, and even more typically from 0.1 to 1.0 g/cm³, and most typically from 0.2 to 0.75 g/cm³), or a specific surface area from 50 to 3,000 m²/g (more typically from 200 to 2,000 m²/g, and most typically from 500 to 1,500 m²/g).

This optional blowing agent is not required if the graphene material has a content of non-carbon elements (e.g. O, H, N, B, F, Cl, Br, I, etc.) no less than 5% by weight (preferably no less than 10%, further preferably no less than 20%, even more preferably no less than 30% or 40%, and most preferably up to 50%). The subsequent high temperature treatment serves to remove a majority of these non-carbon elements from the graphene material, generating volatile gas species that produce pores or cells in the solid graphene material structure. In other words, quite surprisingly, these non-carbon elements play the role of a blowing agent. Hence, an externally added blowing agent is optional (not required). However, the use of a blowing agent can provide added flexibility in regulating or adjusting the porosity level and pore sizes for a desired application. The blowing agent is typically required if the non-carbon element content is less than 5%, such as pristine graphene that is essentially all-carbon.

The graphene foam produced by the fourth method has the highest thermal conductivity among all graphene foam materials, and also exhibit a highly reversible and durable elastic deformation under tension or compression, enabling good, long-term contact between a heat spreader element and a battery cell surface.

The rechargeable battery that can take advantage of the presently disclosed cooling system may be a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, or supercapacitor.

The following examples serve to provide the best modes of practice for the present disclosure and should not be construed as limiting the scope of the disclosure:

### EXAMPLE 1

### Preparation of Single-Layer Graphene Sheets and Their Heat-Spreader Films from Meso-Carbon Micro-Beads (MCMBs)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO sheets contain oxygen proportion of approximately 35%-47% by weight for oxidation treatment times of 48-96 hours. GO sheets were suspended in water. The GO suspension was cast into thin graphene oxide films on a glass surface and, separately, was also slot die-coated onto a PET film substrate, dried, and peeled off from the PET substrate to form GO films. The GO films were separately heated from room temperature to 2,500° C. and then roll-pressed to obtain reduced graphene oxide (RGO) films for use as a heat spreader. The thermal conductivity of these films was found to be from 1,225 to 1,750 W/mK using Neize heat conductivity measuring device.

### EXAMPLE 2

### Preparation of Pristine Graphene Sheets (0% Oxygen) and Heat Spreader Films

Pristine graphene sheets were produced by using the direct ultrasonication or liquid-phase production process. In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

The pristine graphene sheets were immersed into a 10 mM acetone solution of BPO for 30 min and were then taken out drying naturally in air. The heat-initiated chemical reaction to functionalize graphene sheets was conducted at 80° C. in a high-pressure stainless steel container filled with pure nitrogen. Subsequently, the samples were rinsed thoroughly in acetone to remove BPO residues for subsequent Raman characterization. As the reaction time increased, the characteristic disorder-induced D band around 1330 cm⁻¹ emerged and gradually became the most prominent feature of the Raman spectra. The D-band is originated from the A_{1g} mode breathing vibrations of six-membered sp² carbon rings, and becomes Raman active after neighboring sp² carbon atoms are converted to sp³ hybridization. In addition, the double resonance 2D band around 2670 cm⁻¹ became significantly weakened, while the G band around 1580 cm⁻¹ was broadened due to the presence of a defect-induced D′ shoulder peak at ˜1620 cm⁻¹. These observations suggest that covalent C—C bonds were formed and thus a degree of structural disorder was generated by the transformation from sp² to sp³ configuration due to reaction with BPO.

The functionalized graphene sheets were re-dispersed in water to produce a graphene dispersion. The dispersion was then made into graphene films using comma coating and subjected to heat treatments up to 2,500° C. The heat spreader films obtained from functionalized graphene sheets exhibit a thermal conductivity from 1,450 to 1,750 W/mK. On a separate basis, non-functionalized pristine graphene powder was directly compressed into graphene films (aggregates of graphene sheets) using pairs of steel rollers; no subsequent heat treatment was conducted. These graphene films exhibit a thermal conductivity typically from approximately 600 to about 1,000 W/mK.

### EXAMPLE 3

### Preparation of Graphene Fluoride Sheets and Heat Spreader Films

Several processes have been used by us to produce GF, but only one process is herein described as an example. In a typical procedure, highly exfoliated graphite (HEG) was prepared from intercalated compound C₂F.xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion, but a longer sonication time ensured better stability. Upon extrusion to form wet films on a glass surface with the solvent removed, the dispersion became brownish films formed on the glass surface. The dried films, upon drying and roll-pressing, became heat spreader films having a reasonably good thermal conductor (thermal conductivity from 250 to 750 W/mK), yet an electrical insulator. The unique combination of electrical insulation and thermal conduction characteristics is of particular interest for battery heating configurations wherein there is no concern of any potential negative effect cause by an electrical conductor.

### EXAMPLE 4

### Preparation of Nitrogenated Graphene Sheets and Graphene Films for Use as a Heat Spreader Element

Graphene oxide (GO), synthesized in Example 1, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene/urea mass ratios of 1/0.5, 1/1 and 1/2 have the nitrogen contents of 14.7, 18.2 and 17.5 wt. %, respectively, as found by elemental analysis. These nitrogenated graphene sheets, without prior chemical functionalization, remain dispersible in water. The resulting suspensions were then coated and made into wet films and then dried. The dried films were roll-pressed to obtain graphene films, having a thermal conductivity from 350 to 820 W/mK. These films are also electrical insulators.

1. A cooling system for a battery module or pack comprising one or a plurality of battery cells, the system comprising a graphene heat spreader element configured to be in thermal communication with the battery cells; and a cooling means in thermal communication with the heat spreader element and configured to transport heat generated by the battery cells through the heat spreader element to the cooling means when the battery cell is discharged.

2. The cooling system of claim 1, further comprising a thermal interface material (TIM) coupled to at least one of the battery cells and the heat spreader element.

3. The cooling system of claim 1, wherein said graphene heat spreader element is in a form of a film, sheet, layer, belt, or band having a thickness from about 0.34 nm to 10 mm.

4. The cooling system of claim 1, wherein said graphene heat spreader element has a thermal conductivity no less than 600 W/mK.

5. The cooling system of claim 1, wherein said graphene heat spreader element has a thermal conductivity no less than 1,000 W/mK.

6. The cooling system of claim 1, wherein said graphene heat spreader element comprises a graphene film containing a graphene material selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

7. The cooling system of claim 2, wherein said thermal interface material comprises a material selected from graphene sheets, graphene foam, graphene-containing paste, graphene-containing polymer composite, flexible graphite sheet, artificial graphite film, particles of Ag, Ag, Cu, Al, brass, steel, Ti, Ni, Mg alloy, silicon nitride, boron nitride, aluminum nitride, boron arsenide, a composite thereof, or a combination thereof.

8. The cooling system of claim 2, wherein said thermal interface material is electrically insulating and thermally conducting, having a thermal conductivity no less than 1 W/mK.

9. The cooling system of claim 2, wherein said thermal interface material comprises a graphene-reinforced plastic or rubbery matrix composite.

10. The cooling system of claim 2, wherein said thermal interface material comprises a graphene foam having a thermal conductivity from 0.1 W/mK to 100 W/mK and said graphene heat spreader element comprises a graphene film having a thermal conductivity from 600 W/mK to 1,800 W/mK.

11. The cooling system of claim 1, wherein the cooling means is selected from a heat sink, a heat pipe, a vapor chamber, a stream of flowing fluid, a bath of a coolant fluid, a thermoelectric device, a heat exchanger, a cooled plate, a radiator, or a combination thereof.

12. The cooling system of claim 1, wherein the heat spreader element is in a heat-spreading relation to a surface of the battery cell and receives heat therefrom when the battery cell is discharged to power an external device.

13. The cooling system of claim 1, wherein the heat spreader element is configured to form multiple loading sites (pores) for accommodating individual battery cells.

14. The cooling system of claim 13, wherein said lodging sites comprise cylindrical pores to accommodate cylindrical-shape battery cells or rectangular pores to accommodate rectangular-shape battery cells.

15. The cooling system of claim 1, wherein the battery module comprises a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, nickel metal hydride battery, lead acid battery, lead acid-carbon battery, lead acid-based ultra-battery, lithium-ion capacitor, or supercapacitor.

16. A method of operating a battery cooling system, said method comprising: (a) bringing a graphene heat spreader element in thermal contact with one or a plurality of battery cells in a module or pack to receive heat generated from the battery cells; and (b) directing the heat to transport through the graphene heat spreader element to a cooling means which acts to remove the heat and keeps a battery temperature at or below a desired temperature.

17. The method of claim 16, wherein a thermal interface material is disposed between a surface of a battery cell and the heat spreader element.

18. The method of claim 16, wherein said graphene heat spreader element has a thermal conductivity from 10 W/mK to 1,800 W/mK.

19. The method of claim 16, wherein said graphene heat spreader element comprises a graphene film containing a graphene material selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof.

20. The method of claim 17, wherein said thermal interface material comprises a material selected from graphene sheets, graphene foam, graphene-containing paste, graphene-containing polymer composite, flexible graphite sheet, artificial graphite film, particles of Ag, Ag, Cu, Al, brass, steel, Ti, Ni, Mg alloy, silicon nitride, boron nitride, aluminum nitride, boron arsenide, a composite thereof, or a combination thereof.

21. The method of claim 16, wherein the cooling means is selected from a heat sink, a heat pipe, a vapor chamber, a stream of flowing fluid, a bath of a coolant fluid, a thermoelectric device, a cooled plate, a heat exchanger, a radiator, or a combination thereof.
